(19) United States
(12) Patent Application Publication
(10) Pub. No.: US 2014/0087024 A1
(43) Pub. Date: Mar. 27, 2014

(54) AERATED NOUGAT FOOD PRODUCT

(71) Applicant: CONAGRA FOODS RDM, INC., OMAHA, NE (US)

(72) Inventors: KHALED A. KHATIB, GRAND RAPIDS, MI (US); JAMES CASTELLANO, ALTO, MI (US); MICHELLE SONKSEN, ALTO, MI (US)

(73) Assignee: CONAGRA FOODS RDM, INC., OMAHA, NE (US)

(21) Appl. No.: 14/025,390

(22) Filed: Sep. 12, 2013

Related U.S. Application Data
(60) Provisional application No. 61/704,938, filed on Sep. 24, 2012.

(51) Int. Cl. A23G 3/52

(52) U.S. Cl. CPC A23G 3/52
USPC 426/61; 426/656; 426/302

(57) ABSTRACT

A shelf stable, high protein, high fiber, and/or low fat aerated nougat is described. The aerated nougat can be provided in a nutrition bar, a nutritionally fortified product, an aerated confectionary product, and so forth. The aerated nougat can include mechanically denatured proteins and/or fibers without significantly affecting the texture, taste, and/or shelf stability of the finished product. The aerated nougat can be manufactured using a simplified single-step batch process.

### RELATED APPLICATIONS

The present application claims the benefit under 35 U.S.C. §119(e) of U.S. Provisional Application Ser. No. 61/704,938 filed Sep. 24, 2012, entitled AERATED NOUGAT FOOD PRODUCT. The aforementioned application is incorporated by reference herein in its entirety.

### BACKGROUND

The term “nougat” generally refers to confectionaries made with whipped egg whites and sugar and/or honey. Some nougat can also include roasted nuts and/or candied fruit. Nougat can have various consistencies, ranging from soft and chewy to hard and crunchy.

### SUMMARY

This Summary is provided to introduce a selection of concepts in a simplified form that are further described below in the Detailed Description. This Summary is not intended to identify key and/or essential features of the claimed subject matter. Also, this Summary is not intended to limit the scope of the claimed subject matter in any manner.

Aspects of the disclosure relate to a shelf stable high protein, high fiber, and/or low fat aerated nougat, a food product including aerated nougat (e.g., in the form of a nutrition bar, a nutritionally fortified product, an aerated confectionary product, and so forth), manufacturing and/or batch processing operations for making aerated nougat, and manufacturing and/or batch processing operations for making a food product including aerated nougat. The aerated nougat can include mechanically denatured proteins and/or fibers without significantly affecting the texture, taste, and/or shelf stability of the finished product. Further, manufacturing and/or batch processing operations for making the aerated nougat can be simplified into a single-step batch process.

### DRAWINGS

The Detailed Description is described with reference to the accompanying figures.

FIG. 1 is a block diagram illustrating a manufacturing process for forming nougat frappe, aerated nougat, and a food product in accordance with example implementations of the present disclosure.

### DETAILED DESCRIPTION

Aspects of the disclosure are described more fully hereinafter with reference to the accompanying drawings, which form a part hereof, and which show, by way of illustration, example features. The features can, however, be embodied in many different forms and should not be construed as limited to the combinations set forth herein; rather, these combinations are provided so that this disclosure will be thorough and complete, and will fully convey the scope. Among other things, the features of the disclosure can be embodied as formulations, food products, processes, processes for making food products, and processes for making formulations. The following detailed description is, therefore, not to be taken in a limiting sense.

As more fully set forth below, aspects of the disclosure relate to a shelf stable high protein, high fiber, and/or low fat aerated nougat, a food product including aerated nougat (e.g., in the form of a nutrition bar, a nutritionally fortified product, an aerated confectionary product, and so forth), manufacturing and/or batch processing operations for making aerated nougat, and manufacturing and/or batch processing operations for making a food product including aerated nougat. The aerated nougat can include mechanically denatured proteins and/or fibers without significantly affecting the texture, taste, and/or shelf stability of the finished product. In aspects, the aerated nougat comprises a high level of protein (e.g., from about 5% to about 30% by total weight of the food product) and/or a high level of fiber (e.g., from about 4% to about 10% by total weight of the food product). The aerated nougat can also comprise a low level of fat (e.g., from about 0.5% to about 1.5% by weight of the food product). Further, the aerated nougat can maintain a comparable specific gravity with respect to typical candy bar nougat. For example, the aerated nougat can be light and fluffy. In some aspects, the aerated nougat can be shelf stable, having a shelf life from about nine months to about twelve months or longer.

Manufacturing and/or batch processing operations for making the aerated nougat are simplified and can use lower cook temperatures with respect to typical candy bar nougat processes. Additionally, the manufacturing and/or batch processing operations can be quickly completed without additional thickeners or stabilizers, and without additives, surface active agents, preservatives, or foaming agents. Further, techniques of the present disclosure can be used to make frappes and fortified formula in a single-step batch process, as opposed to typical candy bar processes, where frappe is made in several steps, and then other ingredients are added and mixed with the frappe. For example, in a typical candy bar process, egg whites are whipped into a foam-like substance, added to a nougat composition, and then the nougat composition is aerated (e.g., in a dual batch process).

Ingredients

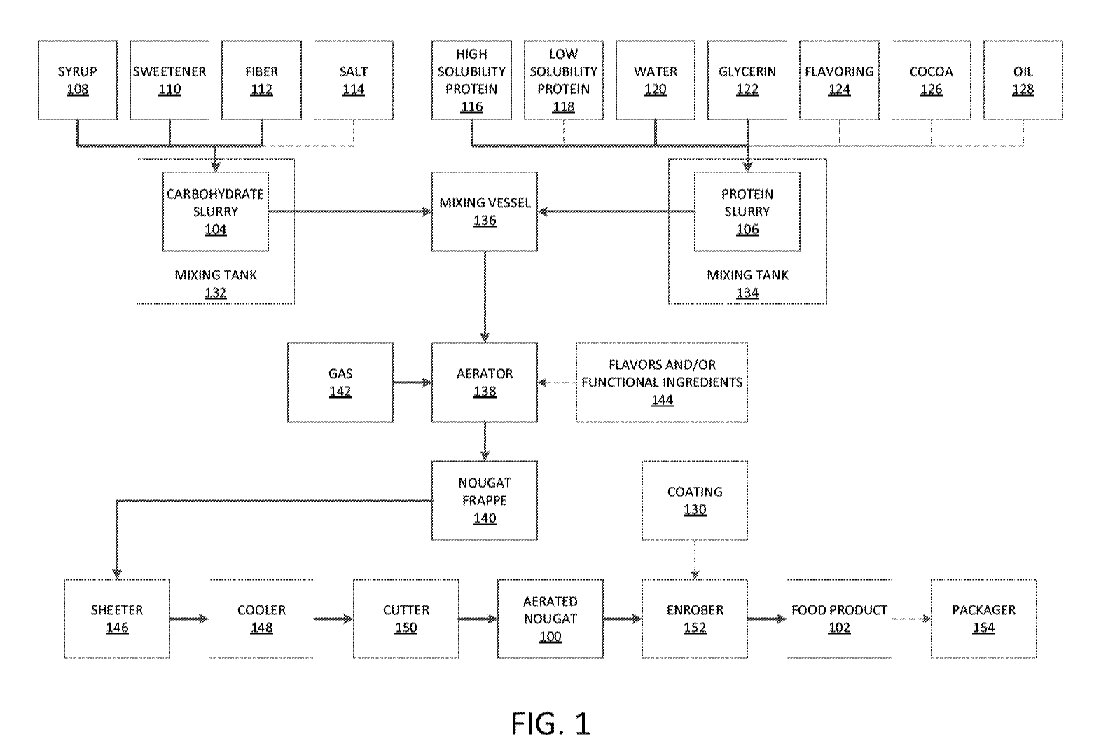

Referring now to FIG. 1, techniques of the present disclosure can be used to form aerated nougat 100. The aerated nougat 100 can be formed as a nougat frappe, which can be incorporated into a food product 102, such as a nougat bar. In some instances, the aerated nougat 100 can be nutritionally enhanced, e.g., including a high level of protein, a high level of fiber, and/or a low level of fat. The aerated nougat 100 can be formed using a carbohydrate slurry 104 and a protein slurry 106. The carbohydrate slurry 104 can comprise warm, high solids syrup.

The carbohydrate slurry formulation can include syrup 108. The syrup 108 can be thick, viscous liquid comprising a solution of sugar in water. For example, the syrup 108 can comprise corn syrup, e.g., made from corn starch using an enzymatic process. However, corn syrup is provided by way of example only and is not meant to be restrictive of the present disclosure. In other aspects, the syrup 108 can be made by dissolving sugar (e.g., cane sugar) in water and/or by reducing one or more naturally sweet juices (e.g., cane juice, sorghum juice, and/or maple sap). In one aspect, the syrup 108 can be from about 17% to about 21% by total weight of the food product 102. In other aspects, the syrup 108 can be from about 15% to about 25% by total weight of the food product 102. For instance, the syrup 108 can be from about 15%, 16%, 17%, 18%, 19%, 20%, 21%, 22%, 23%, 24%, 25% to about 15%, 16%, 17%, 18%, 19%, 20%, 21%, 22%, 23%, 24%, 25% by total weight of the food product 102.

The carbohydrate slurry formulation can include sweetener 110. The sweetener 110 can be sweet-flavored carbohydrates. For example, the sweetener 110 can comprise sugar (e.g., sucrose). However, sugar is provided by way of example only and is not meant to be restrictive of the present disclosure. In other aspects, the sweetener 110 can comprise sugar alcohol (e.g., lactitol, hydrogenated starch hydrolysates, mannitol, glycerol, sorbitol, arabitol, erythritol, maltitol, and/or xylitol), reduced calorie sweeteners, high intensity sweeteners (e.g., sucralose), various combinations thereof, and so forth. In one aspect, the sweetener 110 can be from about 17% to about 21% by total weight of the food product 102. In other aspects, the sweetener 110 can be from about 15% to about 25% by total weight of the food product 102. For instance, the sweetener 110 can be from about 15%, 16%, 17%, 18%, 19%, 20%, 21%, 22%, 23%, 24%, 25% to about 15%, 16%, 17%, 18%, 19%, 20%, 21%, 22%, 23%, 24%, 25% by total weight of the food product 102.

The carbohydrate slurry formulation can include fiber 112. The fiber 112 can be high solubility, low viscosity dietary fiber. For example, the fiber 112 can comprise chicory root extract. However, chicory root extract is provided by way of example only and is not meant to be restrictive of the present disclosure. In other aspects, the fiber 112 can comprise inulin, polydextrose, maltodextrin, corn fiber, various combinations thereof, and so forth. In one aspect, the fiber 112 can be from about 4% to about 8% by total weight of the food product 102. In other aspects, the fiber 112 can be from about 0% to about 10% by total weight of the food product 102. For instance, the fiber 112 can be from about 0%, 1%, 2%, 3%, 4%, 5%, 6%, 7%, 8%, 9%, 10% to about 0%, 1%, 2%, 3%, 4%, 5%, 6%, 7%, 8%, 9%, 10% by total weight of the food product 102.

In some instances, the carbohydrate slurry formulation can include salt 114. In other instances, the carbohydrate slurry formulation does not necessarily include salt 114. The salt 114 can comprise refined salt, including primarily sodium chloride (NaCl). However, refined salt is provided by way of example only and is not meant to be restrictive of the present disclosure. In other aspects, the salt 114 can comprise unrefined salt, such as unrefined sea salt. The salt 114 can also comprise other nutritive and/or non-nutritive substances, such as iodine, iodide, fluoride, anti-caking agents, iron, folic acid, potassium, various combinations thereof, and so forth. In one aspect, the salt 114 can be from about 0.03% to about 0.07% by total weight of the food product 102. In other aspects, the salt 114 can be from about 0.00% to about 0.10% by total weight of the food product 102. For instance, the salt 114 can be from about 0.00%, 0.01%, 0.02%, 0.03%, 0.04%, 0.05%, 0.06%, 0.07%, 0.08%, 0.09%, 0.10% to about 0.00%, 0.01%, 0.02%, 0.03%, 0.04%, 0.05%, 0.06%, 0.07%, 0.08%, 0.09%, 0.10% by total weight of the food product 102.

The protein slurry 106 can comprise high solubility, low viscosity protein. The protein slurry formulation can include high solubility protein 116 capable of being mechanically denatured upon beating, whipping, and/or shearing. Mechanical denaturing during aeration can be used to disrupt the normal alpha-helix and beta sheets in the high solubility protein 116, uncoiling the proteins into random shapes. For example, the high solubility protein 116 can comprise dried egg albumen (whites). The egg whites can be foamed during aeration. When the egg foam is heated, the egg proteins stretch to allow for more expansion. This can increase the volume of the final aerated product. However, dried egg whites are provided by way of example only and are not meant to be restrictive of the present disclosure. In other aspects, the high solubility protein 116 can comprise one or more proteins that shear well during high speed mixing and incorporate air to create stable foam (e.g., various soy proteins, dairy proteins, and so forth).

In one aspect, the high solubility protein 116 can be from about 10% to about 20% by total weight of the food product 102. In other aspects, the high solubility protein 116 can be from about 5% to about 25% by total weight of the food product 102. For instance, the high solubility protein 116 can be from about 5%, 6%, 7%, 8%, 9%, 10%, 11%, 12%, 13%, 14%, 15%, 16%, 17%, 18%, 19%, 20%, 21%, 22%, 23%, 24%, 25% to about 5%, 6%, 7%, 8%, 9%, 10%, 11%, 12%, 13%, 14%, 15%, 16%, 17%, 18%, 19%, 20%, 21%, 22%, 23%, 24%, 25% by total weight of the food product 102. In another aspect, the high solubility protein 116 can be from about 2.0% to about 4.0% by total weight of the food product 102. In other aspects, the high solubility protein 116 can be from about 1.0% to about 5.0% by total weight of the food product 102. For example, the high solubility protein 116 can be from about 1.0%, 1.5%, 2.0%, 2.5%, 3.0%, 3.5%, 4.0%, 4.5%, 5.0% to about 1.0%, 1.5%, 2.0%, 2.5%, 3.0%, 3.5%, 4.0%, 4.5%, 5.0% by total weight of the food product 102.

In some instances, the protein slurry formulation can include low solubility protein 118, e.g., carrier proteins that are not mechanically denatured during aeration and provide the aerated nougat 100 with a shorter texture. In other instances, the protein slurry formulation does not necessarily include low solubility protein 118. The low solubility protein 118 can comprise whey protein concentrate. However, whey protein concentrate is provided by way of example only and is not meant to be restrictive of the present disclosure. In other aspects, the low solubility protein 118 can comprise casein, total milk (e.g., whey and casein), soy proteins, and so forth. In one aspect, the low solubility protein 118 can be from about 5% to about 10% by total weight of the food product 102. In other aspects, the low solubility protein 118 can be from about 0% to about 15% by total weight of the food product 102. For instance, the low solubility protein 118 can be from about 0%, 1%, 2%, 3%, 4%, 5%, 6%, 7%, 8%, 9%, 10%, 11%, 12%, 13%, 14%, 15% to about 0%, 1%, 2%, 3%, 4%, 5%, 6%, 7%, 8%, 9%, 10%, 11%, 12%, 13%, 14%, 15% by total weight of the food product 102.

The protein slurry formulation can include water 120. The water 120 can be purified (e.g., mechanically filtered or processed). For example, the water 120 can be purified using distillation, deionization, reverse osmosis, carbon filtration, microfiltration, ultrafiltration, ultraviolet oxidation, electrodialysis, various combinations thereof, and so forth. In one aspect, the water 120 can be from about 3% to about 7% by total weight of the food product 102. In other aspects, the water 120 can be from about 1% to about 10% by total weight of the food product 102. For instance, the water 120 can be from about 1%, 2%, 3%, 4%, 5%, 6%, 7%, 8%, 9%, 10% to about 1%, 2%, 3%, 4%, 5%, 6%, 7%, 8%, 9%, 10% by total weight of the food product 102.

The protein slurry formulation can include glycerin 122. The glycerin 122 is soluble in the water 120 and has a hygroscopic effect, e.g., attracting and holding water molecules. This effect can be used to control water activity in the food product 102 and provide increased shelf stability. Further, the glycerin 122 can be used as a humectant to maintain a soft and moist nougat texture and/or to inhibit graining or large sugar crystal growth in the aerated nougat 100. In one aspect, the glycerin 122 can be from about 3% to about 7% by total weight of the food product 102. In other aspects, the glycerin 122 can be from about 1% to about 10% by total weight of the food product 102. For instance, the glycerin 122 can be from about 1%, 2%, 3%, 4%, 5%, 6%, 7%, 8%, 9%, 10% to about 1%, 2%, 3%, 4%, 5%, 6%, 7%, 8%, 9%, 10% by total weight of the food product 102.

In some instances, the protein slurry formulation can include flavoring 124. In other instances, the protein slurry formulation does not necessarily include flavoring 124. The flavoring 124 can be natural and/or artificial flavoring. In one aspect, the flavoring 124 can be from about 0.05% to about 0.15% by total weight of the food product 102. In other aspects, the flavoring 124 can be from about 0.00% to about 0.20% by total weight of the food product 102. For instance, the flavoring 124 can be from about 0.00%, 0.01%, 0.02%, 0.03%, 0.04%, 0.05%, 0.06%, 0.07%, 0.08%, 0.09%, 0.10%, 0.11%, 0.12%, 0.13%, 0.14%, 0.15%, 0.16%, 0.17%, 0.18%, 0.19%, 0.20% to about 0.00%, 0.01%, 0.02%, 0.03%, 0.04%, 0.05%, 0.06%, 0.07%, 0.08%, 0.09%, 0.10%, 0.11%, 0.12%, 0.13%, 0.14%, 0.15%, 0.16%, 0.17%, 0.18%, 0.19%, 0.20% by total weight of the food product 102.

In some instances, the protein slurry formulation can include cocoa 126. In other instances, the protein slurry formulation does not necessarily include cocoa 126. The cocoa 126 can be used to mask and/or complement flavors of the high solubility protein 116, e.g., when egg protein is used, which can contribute a slight sulfury off-note to the taste profile of the aerated nougat 100. However, cocoa 126 is provided by way of example only and is not meant to be restrictive of the present disclosure. In other aspects, different ingredients can be used in place of or in addition to cocoa 126 to mask and/or complement flavors contributed by the other ingredients. Example ingredients include, but are not necessarily limited to: chocolate (e.g., milk chocolate, dark chocolate, and so forth), chocolate flavoring, nuts (almonds, walnuts, pistachios, hazelnuts, macadamia nuts), nut flavoring, peanuts, peanut flavoring, fruit, fruit flavoring, coffee, coffee flavoring, various combinations thereof, and so forth. The flavorings can be natural and/or artificial flavorings. In one aspect, the cocoa 126 can be from about 0.5% to about 1.5% by total weight of the food product 102. In other aspects, the cocoa 126 can be from about 0.0% to about 2.0% by total weight of the food product 102. For instance, the cocoa 126 can be from about 0.0%, 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0% to about 0.0%, 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0% by total weight of the food product 102.

In some instances, the protein slurry formulation can include melted oil 128. In other instances, the protein slurry formulation does not necessarily include oil 128. The oil 128 can be a glyceride with at least one fatty acid and/or one or more liquid oils, such as a liquid vegetable oil. The oil 128 can be added to decrease stickiness and/or act as a release aid during manufacturing. For example, the oil 128 can comprise palm oil. However, palm oil is provided by way of example only and is not meant to be restrictive of the present disclosure. In other aspects, the oil 128 can comprise a liquid vegetable oil such as coconut oil, corn oil, cottonseed oil, olive oil, peanut oil, rapeseed oil, canola oil, safflower oil, sesame oil, soybean oil, sunflower oil, various combinations thereof, and so forth. Additionally, the oil 128 can comprise one or more antioxidants for preserving the oil 128. In one aspect, the oil 128 can be from about 0.5% to about 1.5% by total weight of the food product 102. In other aspects, the oil 128 can be from about 0.0% to about 2.0% by total weight of the food product 102. For instance, the oil 128 can be from about 0.0%, 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0% to about 0.0%, 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0% by total weight of the food product 102.

In some instances, the aerated nougat 100 can be coated to form the food product 102. In other instances, the food product 102 is not necessarily coated. The aerated nougat 100 can include a coating 130 designed to protect the integrity of the aerated nougat 100, mask and/or complement one or more flavors of the aerated nougat 100, add a particular taste and/or texture profile to the food product 102, and so forth. For example, the coating 130 can comprise a chocolate coating including whey protein concentrate, palm kernel oil, maltitol, cocoa powder, sugar, soy lecithin, and vanillin. However, chocolate coating is provided by way of example only and is not meant to be restrictive of the present disclosure. In other aspects, the coating 130 can comprise other formulations including, but not necessarily limited to: nut coatings, peanut coatings, fruit coatings, coffee coatings, various combinations thereof, and so forth. In one aspect, the coating 130 can be from about 30% to about 35% by total weight of the food product 102. In other aspects, the coating 130 can be from about 25% to about 40% by total weight of the food product 102. For instance, the coating 130 can be from about 25%, 26%, 27%, 28%, 29%, 30%, 31%, 32%, 33%, 34%, 35%, 36%, 37%, 38%, 39%, 40% to about 25%, 26%, 27%, 28%, 29%, 30%, 31%, 32%, 33%, 34%, 35%, 36%, 37%, 38%, 39%, 40% by total weight of the food product 102.

Manufacturing Processes and Food Products

The syrup 108, sweetener 110, fiber 112, and possibly other ingredients of the carbohydrate slurry 104 can be mixed in a first mixing tank 132 to form the carbohydrate slurry 104. The first mixing tank 132 can be a heating and agitation tank/cooker. In one aspect, the carbohydrate slurry 104 can be heated in the first mixing tank 132 to a controlled temperature of about 250 degrees Fahrenheit (° F.). In other aspects, the carbohydrate slurry 104 can be heated in the first mixing tank 132 to temperatures from about 230° F. to about 270° F. For instance, the carbohydrate slurry 104 can be heated in the first mixing tank 132 to temperatures from about 230° F., 232° F., 234° F., 236° F., 238° F., 240° F., 242° F., 244° F., 246° F., 248° F., 250° F., 252° F., 254° F., 256° F., 258° F., 260° F., 262° F., 264° F., 266° F., 268° F., 270° F. to about 230° F., 232° F., 234° F., 236° F., 238° F., 240° F., 242° F., 244° F., 246° F., 248° F., 250° F., 252° F., 254° F., 256° F., 258° F., 260° F., 262° F., 264° F., 266° F., 268° F., 270° F.

In one aspect, the carbohydrate slurry 104 can be heated in the first mixing tank 132 from about 10 minutes (min) to about 15 min. In other aspects, the carbohydrate slurry 104 can be heated in the first mixing tank 132 from about one min to about 30 min. For instance, the carbohydrate slurry 104 can be heated in the first mixing tank 132 from about 1 min, 2 min, 3 min, 4 min, 5 min, 6 min, 7 min, 8 min, 9 min, 10 min, 11 min, 12 min, 13 min, 14 min, 15 min, 16 min, 17 min, 18 min, 19 min, 20 min, 21 min, 22 min, 23 min, 24 min, 25 min, 26 min, 27 min, 28 min, 29 min, 30 min to about 1 min, 2 min, 3 min, 4 min, 5 min, 6 min, 7 min, 8 min, 9 min, 10 min, 11 min, 12 min, 13 min, 14 min, 15 min, 16 min, 17 min, 18 min, 19 min, 20 min, 21 min, 22 min, 23 min, 24 min, 25 min, 26 min, 27 min, 28 min, 29 min, 30 min.

The high solubility protein 116, water 120, glycerin 122, and possibly other ingredients of the protein slurry 106 can be mixed in a second mixing tank 134 to form the protein slurry 106. The second mixing tank 134 can be a heating and agitation tank/cooker. In one aspect, the high solubility protein 116, water 120, and glycerin 122 can be heated in the second mixing tank 134 to a controlled temperature of about 140° F. or less. In other aspects, the high solubility protein 116, water 120, and glycerin 122 can be heated in the second mixing tank 134 to temperatures from about 120° F. to about 160° F. For instance, the high solubility protein 116, water 120, and glycerin 122 can be hydrated in the second mixing tank 134 to temperatures from about 120° F., 122° F., 124° F., 126° F., 128° F., 130° F., 132° F., 134° F., 136° F., 138° F., 140° F., 142° F., 144° F., 146° F., 148° F., 150° F., 152° F., 154° F., 156° F., 158° F., 160° F. to about 120° F., 122° F., 124° F., 126° F., 128° F., 130° F., 132° F., 134° F., 136° F., 138° F., 140° F., 142° F., 144° F., 146° F., 148° F., 150° F., 152° F., 154° F., 156° F., 158° F., 160° F. In one aspect, the protein 116 is not substantially denatured during formation of the protein slurry. For example, the protein slurry can be mixed at a temperature that does not substantial denature the protein in a thermal manner. In other aspects, the protein slurry can be mixed a shear force that does not substantially denature the protein in a mechanical manner. Stated another way, protein 116 is not substantially denatured in a mechanical, thermal and/or chemical manner during the formation of the protein slurry. As an example, the protein slurry can include less than about 20%, 19%, 18%, 17%, 16%, 15%, 14%, 13%, 12%, 11%, 10%, 9%, 8%, 7%, 6%, 5%, 4%, 3%, 2%, 1% denatured protein by total weight of the protein 116 in the protein slurry.

In one aspect, the high solubility protein 116, water 120, and glycerin 122 can be heated in the second mixing tank 134 from about 10 min to about 15 min. In other aspects, the high solubility protein 116, water 120, and glycerin 122 can be heated in the second mixing tank 134 from about one min to about 30 min. For instance, the high solubility protein 116, water 120, and glycerin 122 can be heated in the second mixing tank 134 from about 1 min, 2 min, 3 min, 4 min, 5 min, 6 min, 7 min, 8 min, 9 min, 10 min, 11 min, 12 min, 13 min, 14 min, 15 min, 16 min, 17 min, 18 min, 19 min, 20 min, 21 min, 22 min, 23 min, 24 min, 25 min, 26 min, 27 min, 28 min, 29 min, 30 min to about 1 min, 2 min, 3 min, 4 min, 5 min, 6 min, 7 min, 8 min, 9 min, 10 min, 11 min, 12 min, 13 min, 14 min, 15 min, 16 min, 17 min, 18 min, 19 min, 20 min, 21 min, 22 min, 23 min, 24 min, 25 min, 26 min, 27 min, 28 min, 29 min, 30 min.

Then, any additional ingredients (e.g., the low solubility protein 118, flavoring 124, cocoa 126, and/or the melted oil 128) can be added to the high solubility protein 116, water 120, and glycerin 122 of the protein slurry 106. Further, in some instances, the carbohydrate slurry 104 can be added to the protein slurry 106 in the second mixing tank 134. In one aspect, the protein slurry 106 with the additional ingredients can be heated in the second mixing tank 134 from about five min to about 10 min. In other aspects, the protein slurry 106 with the additional ingredients can be heated in the second mixing tank 134 from about one min to about 30 min. For instance, the protein slurry 106 with the additional ingredients can be heated in the second mixing tank 134 from about 1 min, 2 min, 3 min, 4 min, 5 min, 6 min, 7 min, 8 min, 9 min, 10 min, 11 min, 12 min, 13 min, 14 min, 15 min, 16 min, 17 min, 18 min, 19 min, 20 min, 21 min, 22 min, 23 min, 24 min, 25 min, 26 min, 27 min, 28 min, 29 min, 30 min to about 1 min, 2 min, 3 min, 4 min, 5 min, 6 min, 7 min, 8 min, 9 min, 10 min, 11 min, 12 min, 13 min, 14 min, 15 min, 16 min, 17 min, 18 min, 19 min, 20 min, 21 min, 22 min, 23 min, 24 min, 25 min, 26 min, 27 min, 28 min, 29 min, 30 min.

In aspects, the protein slurry 106 can have a viscosity from about 15,000 centipoises (cps) to about 300,000 cps. For instance, the protein slurry 106 can have a viscosity from about 15,000 cps, 30,000 cps, 45,000 cps, 60,000 cps, 75,000 cps, 90,000 cps, 105,000 cps, 120,000 cps, 135,000 cps, 150,000 cps, 165,000 cps, 180,000 cps, 195,000 cps, 210,000 cps, 225,000 cps, 240,000 cps, 255,000 cps, 270,000 cps, 285,000 cps, 300,000 cps to about 15,000 cps, 30,000 cps, 45,000 cps, 60,000 cps, 75,000 cps, 90,000 cps, 105,000 cps, 120,000 cps, 135,000 cps, 150,000 cps, 165,000 cps, 180,000 cps, 195,000 cps, 210,000 cps, 225,000 cps, 240,000 cps, 255,000 cps, 270,000 cps, 285,000 cps, 300,000 cps.

The mixed and heated carbohydrate slurry 104 and protein slurry 106 are then combined in a mixing vessel 136 and blended (e.g., at least substantially homogeneously blended). Mixing the syrup phase with protein (and possibly fat) can facilitate dispersal of the protein and other nutritional ingredients and/or prevent or minimize clumping. This technique can be particularly useful when other dry ingredients are added, such as fiber and/or carrier proteins (e.g., proteins having limited whipping functionality used to increase dietary protein levels as previously described). Further, adding sugars before air injection can delay the formation of foam during initial mixing steps and/or can stabilize the foam during strong shear mixing, thus providing the aerated nougat 100 with a finer texture. The mixing vessel 136 can be a kettle mixer with a scraped surface that provides low agitation.

In one aspect, the carbohydrate slurry 104 and the protein slurry 106 can be mixed in the mixing vessel 136 to a temperature of about 160° F. In other aspects, the carbohydrate slurry 104 and the protein slurry 106 can be mixed in the mixing vessel 136 to temperatures from about 140° F. to about 180° F. For instance, the carbohydrate slurry 104 can be mixed in the mixing vessel 136 to temperatures from about 140° F., 142° F., 144° F., 146° F., 148° F., 150° F., 152° F., 154° F., 156° F., 158° F., 160° F., 162° F., 164° F., 166° F., 168° F., 170° F., 172° F., 174° F., 176° F., 178° F., 180° F. to about 140° F., 142° F., 144° F., 146° F., 148° F., 150° F., 152° F., 154° F., 156° F., 158° F., 160° F., 162° F., 164° F., 166° F., 168° F., 170° F., 172° F., 174° F., 176° F., 178° F., 180° F. In one aspect, the carbohydrate slurry 104 can be mixed in the mixing vessel 136 for about 10 min. In other aspects, the carbohydrate slurry 104 can be mixed in the mixing vessel 136 from about five min to about 15 min. For instance, the carbohydrate slurry 104 can be heated in the mixing vessel 136 from about 5 min, 6 min, 7 min, 8 min, 9 min, 10 min, 11 min, 12 min, 13 min, 14 min, 15 min to about 5 min, 6 min, 7 min, 8 min, 9 min, 10 min, 11 min, 12 min, 13 min, 14 min, 15 min.

The blended carbohydrate and protein mixture is then supplied to an aerator 138 configured for simultaneous high shear mixing and aeration. At the inlet of the high shear mixing unit, a liquid phase and a gas phase come together and are homogenized using flow control and controlled pressure. In this manner, the protein and fiber can be simultaneously aerated and sheared to incorporate an appreciable volume of a gas and form nougat frappe 140 while mechanically denaturing the protein. For example, in aspects, the protein (e.g., the high solubility protein 116) and/or the fiber (e.g., the fiber 112) in the blended carbohydrate and protein mixture is mechanically denatured upon whipping and shearing in the aerator 138 primarily by the mechanical action of the aerator 138 (as opposed to being denatured by another mechanism, such as high temperature cooking) The high solubility protein 116 can be mechanically denatured from about 5%, 10%, 15%, 20%, 25%, 30%, 35%, 40%, 45%, 50%, 55%, 60%, 65%, 70%, 75%, 80%, 85%, 90%, 95% to about 5%, 10%, 15%, 20%, 25%, 30%, 35%, 40%, 45%, 50%, 55%, 60%, 65%, 70%, 75%, 80%, 85%, 90%, 95% by total weight of the high solubility protein 116. In another aspect, greater than 5%, 10%, 15%, 20%, 25%, 30%, 35%, 40%, 45%, 50%, 55%, 60%, 65%, 70%, 75%, 80%, 85%, 90%, and 95% of the high solubility protein 116 can be mechanically denatured.

Use of the aerator 138 in this continuous aeration, single-step frappe process can provide constant shear to the formulation, as well as temperature control and/or controllable bubble size distribution. Further, the aerated nougat 100 can be made using pumpable foods with low to high viscosity formulation slurries. At the aerator 138, foam is generated as a gas 142 is added to the blended carbohydrate and protein mixture using, for instance, pressurized gas injection (e.g., to obtain maximum overrun). The gas 142 can be an edible gas. For example, the gas 142 can comprise filtered air. However, filtered air is provided by way of example only and is not meant to be restrictive of the present disclosure. In other aspects, the gas 142 can comprise nitrogen, carbon dioxide (CO₂), other inert gases, various combinations thereof, and so forth.

In aspects, the overrun of the resultant nougat frappe 140 can be adjusted via injection of the gas 142 to provide a desired creaminess and soft to hard texture for the aerated nougat 100. In one aspect, the amount of gas 142 injected into the formulation using the aerator 138 can be adjusted so that the aerated nougat 100 comprises from about 50% to about 75% by volume of gas, is not subject to excessive drying, firming, and/or hardening, and does not bleed oil and/or collapse. In other aspects, the amount of gas 142 injected into the formulation using the aerator 138 can be adjusted so that the aerated nougat 100 comprises from about 5% to about 95% by volume of gas. For instance, the amount of gas 142 injected into the formulation using the aerator 138 can be from about 5%, 10%, 15%, 20%, 25%, 30%, 35%, 40%, 45%, 50%, 55%, 60%, 65%, 70%, 75%, 80%, 85%, 90%, 95% to about 5%, 10%, 15%, 20%, 25%, 30%, 35%, 40%, 45%, 50%, 55%, 60%, 65%, 70%, 75%, 80%, 85%, 90%, 95% by volume of gas.

In some instances, flavors and/or functional ingredients 144 can be added to the blended carbohydrate and protein mixture in the aerator 138 and infused into the nougat frappe 140. The flavors can be natural and/or artificial flavors. Examples of natural and artificial flavor components include, but are not necessarily limited to: butter flavoring, chocolate flavoring, chocolate mint flavoring, mint flavoring, honey flavoring, vanilla flavoring, coconut flavoring, peppermint flavoring, coffee flavoring, various combinations thereof, and so forth. The functional ingredients can be designed to nutritionally fortify the aerated nougat 100. Examples of functional ingredient components include, but are not necessarily limited to: omega fatty acids, bioactive and performance peptides, bio-clinical fruits and/or vegetable extracts, symbiotics, probiotics, antioxidants, various combinations thereof, and so forth. It should be noted that one or more sugar slurries can also be injected into the aerator 138 and infused into the nougat frappe 140.

In aspects, the nougat frappe 140 can have a specific gravity from about 0.10 to about 0.75. For instance, the nougat frappe 140 can have a specific gravity from about 0.10, 0.15, 0.20, 0.25, 0.30, 0.35, 0.40, 0.45, 0.50, 0.55, 0.60, 0.65, 0.70, 0.75 to about 0.10, 0.15, 0.20, 0.25, 0.30, 0.35, 0.40, 0.45, 0.50, 0.55, 0.60, 0.65, 0.70, 0.75. In one aspect, the nougat frappe 140 can have a water activity from about 0.45 to about 0.55. In other aspects, the nougat frappe 140 can have a water activity from about 0.00 to about 0.70. For instance, the nougat frappe 140 can have a specific gravity from about 0.00, 0.05, 0.10, 0.15, 0.20, 0.25, 0.30, 0.35, 0.40, 0.45, 0.50, 0.55, 0.60, 0.65, 0.70 to about 0.00, 0.05, 0.10, 0.15, 0.20, 0.25, 0.30, 0.35, 0.40, 0.45, 0.50, 0.55, 0.60, 0.65, 0.70. In one aspect, the nougat frappe 140 can have a moisture content from about 0% to about 15% (e.g., to control shelf life stability). For instance, the nougat frappe 140 can have a specific gravity from about 0%, 1%, 2%, 3%, 4%, 5%, 6%, 7%, 8%, 9%, 10%, 11%, 12%, 13%, 14%, 15% to about 0%, 1%, 2%, 3%, 4%, 5%, 6%, 7%, 8%, 9%, 10%, 11%, 12%, 13%, 14%, 15%.

The nougat frappe 140 can be extruded, sheeted (e.g., using a sheeter 146, such as ice cold steel sheeting rollers and an ice cold steel band), cooled (e.g., using a cooler 148), and cut (e.g., using a cutter 150) to form the aerated nougat 100. In some instances, the aerated nougat 100 can then be enrobed (e.g., using an enrober 152) to apply the coating 130 and form the food product 102. The food product 102 can then be packaged (e.g., using a packager 154). However, extruding, sheeting, cooling, cutting, and/or enrobing are provided by way of example only and are not meant to be restrictive of the present disclosure. Thus, in other aspects, the nougat frappe 140 and/or the aerated nougat 100 can be stuffed into a food product 102. cl CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A food product comprising:
syrup from about 15% to about 25% by total weight of the food product;
sweetener from about 15% to about 25% by total weight of the food product;
fiber from about 1% to about 10% by total weight of the food product;
mechanically denatured high solubility protein from about 5% to about 25% by total weight of the food product;
water from about 1% to about 10% by total weight of the food product;
glycerin from about 1% to about 10% by total weight of the food product; and
gas from about 5% to about 95% by volume of the food product.

2. The food product as recited in claim 1, wherein the food product has a specific gravity from about 0.10 to about 0.75.

3. The food product as recited in claim 1, wherein the high solubility protein comprises dried egg albumen.

4. The food product as recited in claim 1, further comprising low solubility protein from about 1% to about 15% by total weight of the food product.

5. The food product as recited in claim 4, wherein the low solubility protein comprises at least one of whey protein concentrate, casein, total milk, or soy protein.

6. The food product as recited in claim 1, further comprising oil from about 1% to about 15% by total weight of the food product.

7. The food product as recited in claim 1, further comprising cocoa from about 0.1% to about 2.0% by total weight of the food product.

8. The food product as recited in claim 1, further comprising at least one of an omega fatty acid, a bioactive peptide, a performance peptide, a bio-clinical fruit extract, a bio-clinical vegetable extract, a symbiotic, a probiotic, or an antioxidant.

9. A method comprising:
forming a carbohydrate slurry by mixing syrup, sweetener, and fiber in a first mixing tank;
forming a protein slurry by mixing high solubility protein, water, and glycerin in a second mixing tank;
mixing the carbohydrate slurry and the protein slurry in a mixing vessel to form an at least substantially homogenous mixture; and
forming nougat frappe by aerating the homogenous mixture using high shear mixing and pressurized gas injection.

10. The method as recited in claim 9, wherein the high solubility protein comprises from about 1% to about 5% by total weight of the nougat frappe.

11. The method as recited in claim 9, wherein the high solubility protein comprises from about 5% to about 25% by total weight of the nougat frappe, and where the high solubility protein is mechanically denatured by the high shear mixing.

12. The method as recited in claim 9, wherein the syrup, sweetener, and fiber are mixed in the first mixing tank from about one minute to about 30 minutes and heated to a temperature from about 230 degrees Fahrenheit (° F.) to about 270° F.

13. The method as recited in claim 9, wherein the high solubility protein, water, and glycerin are mixed in the second mixing tank from about one minute to about 30 minutes and heated to a temperature from about 120° F. to about 160° F.

14. The method as recited in claim 9, wherein forming the protein slurry further comprises mixing at least one of low solubility protein, flavoring, cocoa, or oil with the high solubility protein, water, and glycerin.

15. The method as recited in claim 14, wherein the at least one of the low solubility protein, flavoring, cocoa, or oil are added to the second mixing tank and mixed with the high solubility protein, water, and glycerin from about one minute to about 30 minutes.

16. The method as recited in claim 9, wherein the protein slurry has a viscosity from about 15,000 centipoises (cps) to about 300,000 cps.

17. The method as recited in claim 9, wherein the carbohydrate slurry and the protein slurry are mixed in the mixing vessel from about five minutes to about 15 minutes and heated to a temperature from about 140° F. to about 180° F.

18. The method as recited in claim 9, wherein the pressurized gas is injected from about 5% to about 95% by volume of gas.

19. The method as recited in claim 9, further comprising infusing at least one of an omega fatty acid, a bioactive peptide, a performance peptide, a bio-clinical fruit extract, a bio-clinical vegetable extract, a symbiotic, a probiotic, or an antioxidant into the nougat frappe.

20. A method comprising:
forming a carbohydrate slurry by mixing syrup, sweetener, and fiber in a first mixing tank;
forming a protein slurry by mixing high solubility protein, water, and glycerin in a second mixing tank wherein the high solubility protein comprises from about 5% to about 25% by total weight of the nougat frappe, and where the high solubility protein is mechanically denatured by the high shear mixing;
mixing the carbohydrate slurry and the protein slurry in a mixing vessel to form an at least substantially homogenous mixture;
forming nougat frappe by aerating the homogenous mixture using high shear mixing and pressurized gas injection;
extruding, sheeting, cooling, and cutting the nougat frappe to form an aerated nougat; and
enrobing the aerated nougat with a coating.
